(19) United States
(12) Patent Application Publication
(10) Pub. No.: US 2002/0124262 A1
(43) Pub. Date: Sep. 5, 2002

(54) Network based replay portal

(76) Inventors: Andrea Basso, Ocean, NJ (US); Charles Robert Kalmanek JR., Short Hills, NJ (US); Cormac John Sreenan, Morristown, NJ (US); Jacobus E. Van der Merwe, New Providence, NJ (US)

Correspondence Address: Samuel H. Dworetsky, AT&T CORP., P.O. Box 4110, Middletown, NJ, 07748-4110, US

(21) Appl. No.: 09/923,078

(22) Filed: Aug. 6, 2001

Related U.S. Application Data
(63) Continuation of application No. 09/726,576, filed on Dec. 1, 2000, now abandoned.
(60) Provisional application No. 60/168,243, filed on Dec. 1, 1999.
(60) Provisional application No. 60/194,289, filed on Apr. 3, 2000.
(60) Provisional application No. 60/252,708, filed on Nov. 22, 2000.

(51) Int. Cl. H04N 7/173

(52) U.S. Cl. 725/109; 725/110

(57) ABSTRACT

A network based video replay service utilizing broadband technologies on the internet. A replacement for current analog or digital TV offerings that offer the same quality and user experience. The capacity used by current offerings (e.g. on a cable access network) will be freed up for use by the new service. The current schedule based broadcast paradigm users are accustomed to is emulated while at the same time offering on-demand viewing based on personal preference or subscription profile. This hybrid offering can lead to bandwidth savings in the access network with interaction of this service with other services on a common packet based infrastructure.

### CROSS-REFERENCE TO RELATED CASES

This application claims the benefit of U.S. Provisional Application No. 60/168,243 filed on Dec. 1, 1999 and U.S. Provisional Application No. 60/194,289 flied on Apr. 3, 2000.

### BACKGROUND OF THE INVENTION

1. Field of the Invention

A hybrid approach for providing a network based video reply service utilizing broadband technology on the internet.

2. Description of Background Art

Heretofore, a program broadcast for television viewing required a consumer to have a separate tuner or a cable connection to permit a selected televised program to be received for viewing. It was difficult for a consumer to view more than one live performance unless the consumer had two or more televisions with tuners or a cable connected to multiple televisions with corresponding recorders to permit the consumer to video tape a program for subsequent viewing.

Difficulties exist with regard to viewing current television programs due to time constraints wherein a consumer cannot to be available at the specific time of the broadcast. Live video programs also present time constraint problems that are somewhat similar to the timing problems of regular broadcasts.

### SUMMARY AND OBJECTS OF THE INVENTION

The present invention permits a consumer to view one or more live or time shifted performances by providing a network based video replay service that utilizes broadband technologies on the internet. The system operates in an environment where high quality live video is being distributed across a wired and/or wireless IP network.

Live content might enter the IP network “locally,” e.g. from a satellite feed at the headend of a local access plant, or might indeed be carried on IP from the remote live source. The present invention essentially duplicates or emulates the “pure broadcasting,” or more correctly for IP, multicasting, model of current TV networks.

The present invention provides an architecture with a replay portal to this basic infrastructure to change the broadcasting model to a model allowing live and time shifted access to content.

A replay portal becomes the local video access point for customers and provides access to live content, subscribed to by the portal. In addition, a moving window recording of stored and/or previously aired content, e.g. the last 24 hours worth of live content is available to enable on-demand viewing of such content. The viewing by a customer may include the ability to “pause” and “replay” the live content to enable the customer to have greater flexibility in arranging the time of the viewing.

Further, a customer would be permitted to personally record the live content for future viewing. A subscriber would have the possibility to view non-local live content, which is made available by the replay portal. The replay portal might subscribe to such non-local content or obtain it on demand to satisfy a request from one of its customers. Indexing and search functionality are provided to access to the video content of multiple cooperating portals.

These and other objects of the present invention are possible by providing a network based video replay system with a viewing station for enabling a customer to view a video program or video programs. A network is provided for enabling a plurality of access programs to be selectively available to individual viewing stations for viewing by a customer. The network makes available a plurality of video programs for a predetermined period of time to permit users to view selective programs upon demand. The network based video replay system permits video programming of live events that are stored for a predetermined period of time to permit a user to time shift viewing of selective programs upon demand.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic view illustrating a high level view of a network based replay service with various components and variations;

FIG. 2 is a schematic view illustrating a cable access network;

FIG. 3 is a schematic view illustrating a replay portal architecture;

FIG. 4 is a schematic view illustrating a replay portal with a RTSP proxy/storage manager farm;

FIG. 5 is a schematic view illustrating a scalable portal realization;

FIG. 6 is a schematic view illustrating an RTSP client;

FIG. 7 is a schematic view illustrating an RTSP server; and

FIG. 8 is a schematic view illustrating an RTSP proxy and storage manager.

### DETAILED DESCRIPTION OF THE PREFERRED EMBODIMENTS

In describing the features of the present invention with regard to the network, a portal refers to the collective functionality of the system. Whereas, a proxy refers to a specific entity forming part of a portal. Portals can be at the headend or the home depending on the technology.

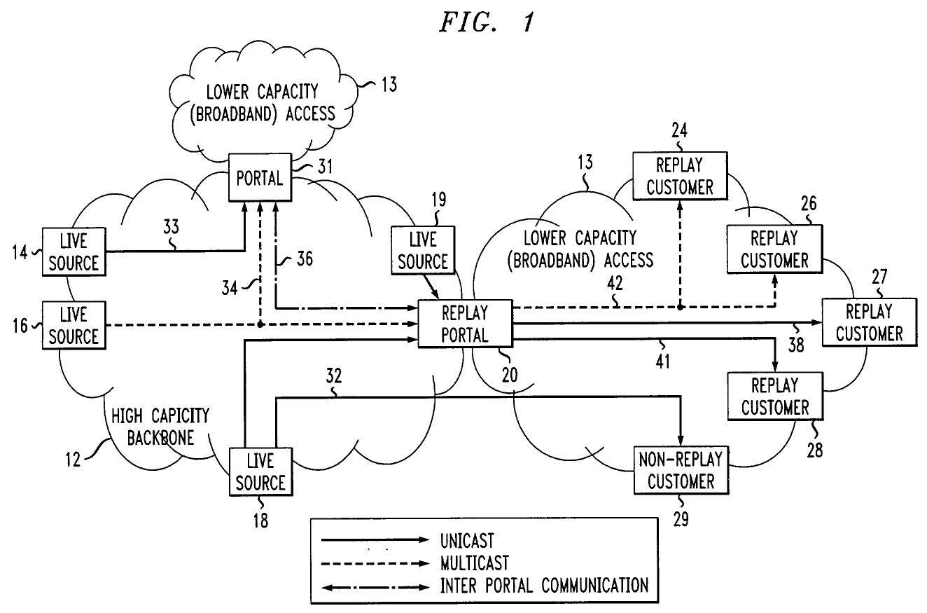

As illustrated in FIG. 1, a network based replay system 10 is provided wherein a high capacity backbone 12 is connected to a plurality of sources for live content 14, 16, 18 and 19 that are connected by unicast or multicast to a replay portal 20. The replay portal 20 is connected by unicast or multicast to a lower capacity broadband access network 13 of individual customers 24, 26, 27 and 28. The present invention permits a customer 29 to be connected directly to live content 18 by means of a unicast connection 32. In addition, a portal 31 may be connected to a live source 14 by a unicast connection 33 or to a live source 16 by means of a multicast connection 34 or to another replay portal 20 by means of an inter portal communication 36. It is clear that live content may be delivered to the replay portal 20 either by a unicast or a multicast connection.

Similarly, from the replay portal 20 downstream content can be delivered to customers 24 and 26 by means of a multicast connection 42 as would be the case when live content is watched by the customers 24 and 26 through the replay portal 20. In addition, a customer 28 can watch on-demand previously stored content from the replay portal 20 by means of a unicast connection 41. Similarly, customer 27 can watch on-demand previously stored content from the replay portal 20 by means of a unicast connection 38.

Customers who do not connect to the replay portal 20 but who are on the lower capacity broadband access network 13 can connect directly to the original live sources, depending on the authorization by the live content provider, as they would do in the absence of the replay server. However, such customers will of course not be able to make use of the replay portal functionality.

The present invention provides a high quality service on broadband access networks. As these access networks increase their access capacity by an order of magnitude or more, access capacity is expected to lag behind backbone capacity for a considerable time to come. Video is only streamed downstream of the replay portal 20 if there are actually consumers of a particular stream downstream of the portal. This can easily be achieved in an IP environment, where streams are delivered via multicast rather than broadcast, and is expected to result in bandwidth savings across the access network.

For example, in a cable based access network the portal is expected to be located in the cable headend. In another embodiment, the portal may be located in a customer's home. As access capacities increase the portal location may move downstream towards the home. Eventually, in a fiber to the home scenario, the portal may be in home. When this happens, the bandwidth savings envisaged by the present invention will become less important but the service interaction and integration aspects will be as important only at a much larger scale.

Single portal services such as persistent pause, replay and subscription service are available with the present invention together with inter portal services such as subscription to remote portal content. Other features of the present invention include remote access to “home” content, wherein a user can access content stored in a portal operated by their “home” service provider from a remote location. Buddy access to personal content is also available in addition to closed user group audiences. Content may be downloaded to a portal at a high speed, i.e. at faster than real time. Content may also be downloaded to a portal or set of portals in order to support load balancing among portals in cases where a large number of customers wish to access the same content.

The present invention allows a basic service equivalent to current TV and as such the basic service offering is still schedule driven access to a variety of live channels. These live channels are transmitted downstream by means of a multicast delivery. The services and features considered below provide substantial enhancements to this basic service.

For a predetermined set of channels the portal 20 stores a moving window of the most recent N hours worth of content for each channel. This feature is referred to as moving window replay of subscribed channels. This stored content is made available to subscribers for on-demand viewing. Different ways of indexing can be provided to this stored content ranging from simple time based schemes to indexing that is content aware. Each on-demand viewer receives a personal copy of the content by means of a unicast connection and can therefore perform pause, seek, fast-forward and replay functions on the stream. Contents is stored in a common shared store.

Customers of the portal service can also watch other live content, i.e. content not subscribed to by the portal, through the portal. This feature is referred to as replay and pause of non-portal-subscribed channels. With this feature of the present invention the portal will realize that this is not content it currently has access to and will therefore contact the actual live upstream server. Content is streamed to the downstream customer via the portal which stores a small moving window of the stream or may store the entire video. This small stored window allows customers to request a replay of a recent part of the stream and to then join the live stream again. Customers can also pause the live stream during which time the portal will increase its storage window up to some limit to enable the customer to unpause and eventually join the live stream again. The storage and state associated with this functionality is not persistent and disappears as soon as the customer stops watching the particular channel. It is to be noted that the present invention might include subscription to live sources.

A small extension of the present invention allows customers to make their own personal recordings which is being stored in a personal account on the portal. This feature of the present invention is referred to as personal recording. Recordings can be initiated in a variety of ways and the contents can be from either subscribed or non-subscribed channels. For example, a user might hit the record button while watching something live at which point in time the portal will either start a persistent store, in the case of a non-subscribed channel, or mark the contents in the common store as having a reference from a personal account. Alternatively a user might record content by pre-selection via a Web interface associated with the portal.

Since the portal is located in the network and on a high capacity backbone it is possible for users to allow access to their personal library of recordings to friends. A user might for example see something that he/she knows is of interest to a friend and start recording it. Having finished the recording the user can simply mail a pointer to his/her friend who can then stream or transfer the content from the portal where it was recorded.

All the features and services listed above are associated with a single portal. A very powerful extension, enabled by the fact that the portal is network based, is to allow interportal exchange of content.

The simplest form of interportal exchange will be interportal-subscription based. This feature of the present invention is referred to as subscription based exchanges. With this feature content stored by a remote portal is transferred to the local portal for on-demand viewing by local customers. Certain non-local channels, stored by a remote portal, might be of sufficient interest to the local community to warrant it forming part of the local portals regular offerings rather than having customers access it from the remote portal directly. An example might be regular or seasonal programming, such as European sporting events. In some cases, for example when there is a time zone difference between the remote and local portals such that live viewing is unlikely, it is possible to transfer content between portals by means of a file transfer protocol rather than streaming. Even if there is immediate demand for such content this “near-live” approach would be acceptable to the majority of the portal customers.

A much more sophisticated means of content exchange between portals might involve users specifying a profile of interest, with portals exchanging content based on the profiles of its local users. This feature of the present invention is referred to as personalized content aware exchanges. In this way users are ensured of receiving up to date streaming contents of the topics they find interesting.

In the above examples, the assumption was that content produced by some live sources was stored, indexed and made available for retransmission by the portals. Such actions will require some agreements between the portal operator and the producers of live content. However in that scenario no special action is required by the content provider. A logical extension of this involves negotiation between the portal operator, or a third party that uses its infrastructure, to directly negotiate with the content provider for specific content.

With regard to a local target audience, in this case the portal becomes the access point for a specific mix of programs targeted at a specific audience. At one end of the spectrum this might resemble the service currently offered by a local TV station. The key point however is that basing this architecture on a packet network allows this type of service to scale to arbitrary small target audiences. For example the target audience might be the local bird-watchers club that obtains and adds to its library programming information of interest provided by a variety of content providers.

A large-scale portal service can be provided by using current IP access technology based on DOCSIS in a traditional hybrid-fiber coax cable plant. For example, IP may be used for all video content distribution, as a replacement for existing analog or digital TV offerings. In practice portal services are likely to be deployed incrementally. However, it is envisioned that an all IP solution is technically feasible through an evolution of the equipment that is currently being deployed for high-speed data service.

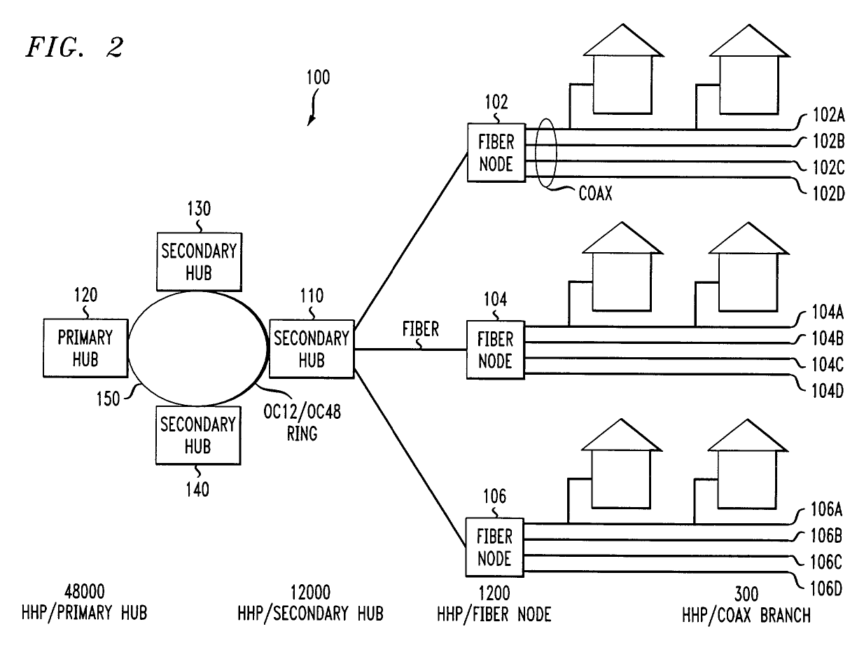

FIG. 2 illustrates the architecture of a typical cable access network 100. The “last mile” of this network 100 is based on coaxial cable that passes approximately 300 households. Four coax “runs” terminate in a fiber node serving approximately 1200 households. These fiber nodes are served by point-to-point fiber from a hub location. Hub sizes range from small hubs supporting a few fiber nodes to large hubs supporting dozens. Smaller, secondary hubs are connected in a ring or mesh to a primary hub or “headend.” To support the broadcast TV services, the headend contains satellite receivers or fiber connections that supply video feeds. For high-speed data services, the head end connects to an ISP point-of-presence.

Television programs are broadcast over 6 MHz channels in the 50- 750 MHz range. Frequencies below 50 MHz are used for upstream transmission. Since frequencies below 50 MHz are more susceptible to ingress noise in the coax plant, upstream transmission typically uses narrower channels, e.g., 1.6 MHz. To support Internet access, at least one 6 MHz channel is reserved for downstream data transmission. Digital data is modulated using either 64 QAM or 256 QAM, supporting either 27 Mbps or 38 Mbps respectively. Data is modulated into the upstream channels using QPSK or 16 QAM, supporting up to 2.56 Mbps.

A customer's home network is connected to the Internet through a cable modem (CM) which connects via the HFC network to a cable modem termination system (CMTS) located in a hub. The CMTS provides RF termination and implements the medium access control protocol, and is typically integrated with an IP Router. Traffic from one or more CMTS's are aggregated at the hub by an aggregation router, which connects via the fiber ring to the head end. The head end typically connects to the ISP point-of-presence using Sonet facilities or dedicated fiber.

It is important to note that the hybrid fiber coax HFC architecture is highly scalable. The present invention is highly scalable in terms of the bandwidth provided per subscriber. At today's low take rates, a single 6 Mhz channel may serve 10-15 fiber nodes. However, the present invention can be scaled at the RF level by serving fewer fiber nodes with a 6 MHz channel, and can be scaled further by subdividing a fiber node so that each coax branch receives a dedicated 6 MHz channel or multiple 6 MHz channels.

The present invention will be used to support an all IP portal service based on the following representative capacity and sizing scenarios. For simplicity, assume that all video content is MPEG2 encoded at 5 Mbps (broadcast quality). It is noted that a packet-based architecture can readily support lower (or higher) rate streams. Thus, with 256 QAM modulation, each 6 MHz channel can support 7 video streams.

The architecture supports both unicast and multicast distribution of video streams over the access network. Multicast is likely to be used for distribution of “live” content or scheduled multicast “events” with stored content. However, unlike today's broadcast distribution paradigm, multicast groups may consist of either a small or large number of users, since users subscribe to multicast groups on demand. Moreover, the portal architecture allows individual users to access individualized content via unicast streams.

Given this flexibility over which streams are actually transmitted over the access network, the capacity requirements will depend strongly on actual usage patterns. Popular “live” programs may be multicast over large segments of the access network, similar to broadcast. However, since access to video streams is on demand, there is likely to be a great deal of statistical multiplexing. Bandwidth in some part of the access network is only used for streams that someone downstream is viewing. Content that has a narrow subscriber base will use bandwidth only in those parts of the network where there are active viewers. Overall, the on demand nature of the service tends to decrease the amount of bandwidth that is needed in this architecture when compared with today's broadcast architecture. On the other hand, portal services such as replay tend to increase the bandwidth requirements. In the worse case, every viewer could be looking at a unicast time-delayed version of a “live” stream.

In an example where every cable subscriber consumes, on the average, a distinct 5 Mbps unicast stream, with 65 streams per coaxial cable segment this requires 296 MHz channels. In the example in FIG. 2, a cable network 100 includes a primary hub 120 and secondary hubs 110, 130 and 140. The primary hub 120 and the secondary hubs 110, 130 and 140 are connected by a ring 150. The secondary hub 110 is connected by fibers to each fiber node 102, 104 and 106 which each serve four cable segments, 102A-102D, 104A-104D and 106A-106D, respectively. A typical hub 110 serves ten fiber nodes. If we assume that every user downstream of the hub is receiving a distinct unicast stream, a hub distributes 8000 distinct streams, or 40 Gbps. Routers capable of forwarding at rates in the 40-320 Gbps range are envisioned as being operative in the present invention.

In practice, when looking at the large user population served by a hub, substantial benefits are likely from multicast transmission. The success of today's broadcast paradigm is predicated to some extent on the fact that many subscribers are interested in the same content. Moreover, it is possible that replay services may only be invoked sporadically. It is also likely that the system would be engineered to a certain probability of blocking for portal requests, e.g., blocking of a rewind request, blocking of a request to receive a new live stream. As a result, the overall bandwidth requirements are likely to be far less than those calculated above, even if such a system were fully deployed. While detailed capacity planning for an IP access network must include the traffic demands for video, voice and data applications, video is likely to be the dominant bandwidth user. Hence, we believe this analysis justifies our assertion that an all IP video distribution architecture is feasible.

If each video device in the home contains a DOCSIS cable modem that is used for “data” and control, when a user requests a video stream from the portal, regardless of whether the stream is distributed unicast or multicast the CMTS must pick a downstream frequency with sufficient capacity to support the stream and instruct the CM to-tune to this frequency. In order to avoid interactions with IP layer forwarding, a cable modem's address must remain the same when it tunes to a new downstream channel. As a result, we assume that the CMTS manages all of the downstream channels that are available to a single cable modem as a single media access control (MAC) layer domain. Since we are dealing primarily with downstream video distribution, the CM does not need to change its upstream frequency.

If the CM address is the same as the real time streaming protocol, RTSP, client address (embedded client), when a client requests a stream using RTSP, if multicast, the client sends an IGMP request to join the group. This sets up the forwarding state. If server uses RSVP, it sends a PATH message, and the client sends a RESV. The RESV informs the CMTS of the client's bandwidth requirements and triggers the channel change. If unicast, same as above without the IGMP request.

The small number of streams per frequency may make it somewhat difficult to receive two broadcast quality streams simultaneously with a single DOCSIS cable modem, since this requires sufficient bandwidth for two streams. In addition, if two clients are receiving a multicast stream and one of them requests a second stream for which there is insufficient capacity, the CMTS needs to tune both client's cable modems to a new frequency to avoid blocking the second stream request. We note that, in some cases, it may be possible to accommodate a lower rate stream, for example, to support a lower resolution image for a picture-in-picture capability. Lower bit rate codecs or wider channels will also alleviate this problem.

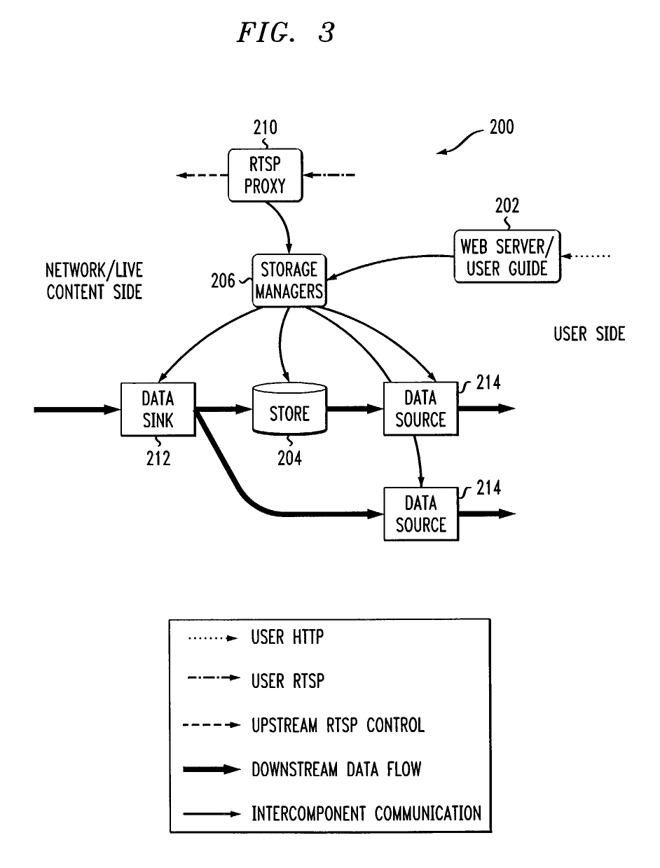

The main architectural components of a replay portal 200 is shown in FIG. 3. The present invention is built around standard IETF protocols namely the Real Time Streaming Protocol (RTSP), the Real Time Transport Protocol (RTP) and the Hypertext Transfer Protocol (HTTP). A user typically starts interaction with the portal by means of accessing a portal Web-server/User-guide 202. This interface provides the user with personalized access to and control of the portal content. Personalized portal content includes the portal-subscribed content (either live or on-demand) as well as any content stored in the user's personal store 204. The Web interface offers a number of ways of indexing the content that is of interest to the user and allows the user to initiate streaming of any such content. In the case of a personal store 204 the user can also perform management functions with the storage manager 206 such as removing previously stored content or setting up the recording of a future streaming event. When a user initiates streaming through the portal Web interface or web server/user guide 202, a helper file is downloaded to the user's browser. The mime type of this file instructs the browser to start up a streaming client application on the user's PC or settop box passing to the application the RTSP URL contained in the helper file.

A user might also make use of the portal for content that is not subscribed to by the portal. In this case the user would not typically make use of the portal web interface. Rather the user will go to a web interface associated with the content source and obtain an RTSP URL in similar fashion as described above. This also means that in this case the user's first interaction with the portal will be through the RTSP interface as described next.

The RTSP URL obtained by the client through either of these approaches is presented to the RTSP proxy 210 on the replay portal 200. The RTSP proxy 210 establishes whether the URL represents content currently stored in the local store 204 or whether it is necessary to establish a connection to an upstream server. If the requested content is available on the server, either live or stored, the proxy initiates delivery of the content to the client. In these cases the RTSP proxy 210 would have contacted the relevant upstream servers beforehand. If the content is not locally available, the RTSP proxy 210 will contact the upstream server and on success will initiate local handling of the content as well as delivery to the client.

The actual manipulation of content on the portal is performed by a set of storage managers 206. Each storage manager 206 is in control of a specific physical data store 204 and controls the way content is added to and removed from the store 204. The storage manager 206 provides the Web interface with information about the contents of a particular store 204, for example to create an RTSP URL to pass back to the client. Similarly the storage manager can tell the RTSP proxy 210 whether a particular URL is currently to be found in the local store 204. The storage managers 206 manipulate the stores 204 under control of the RTSP proxy 210. For example, in the case of live content being viewed through the replay portal 200, the RTSP proxy 210 will instruct the storage manager 206 to create a data sink 212 and a data source 214 for the data path handling of the stream. The data sink receives the content from upstream and writes it to the store 204, while also making the content available to the data source 214 for immediate delivery to the client.

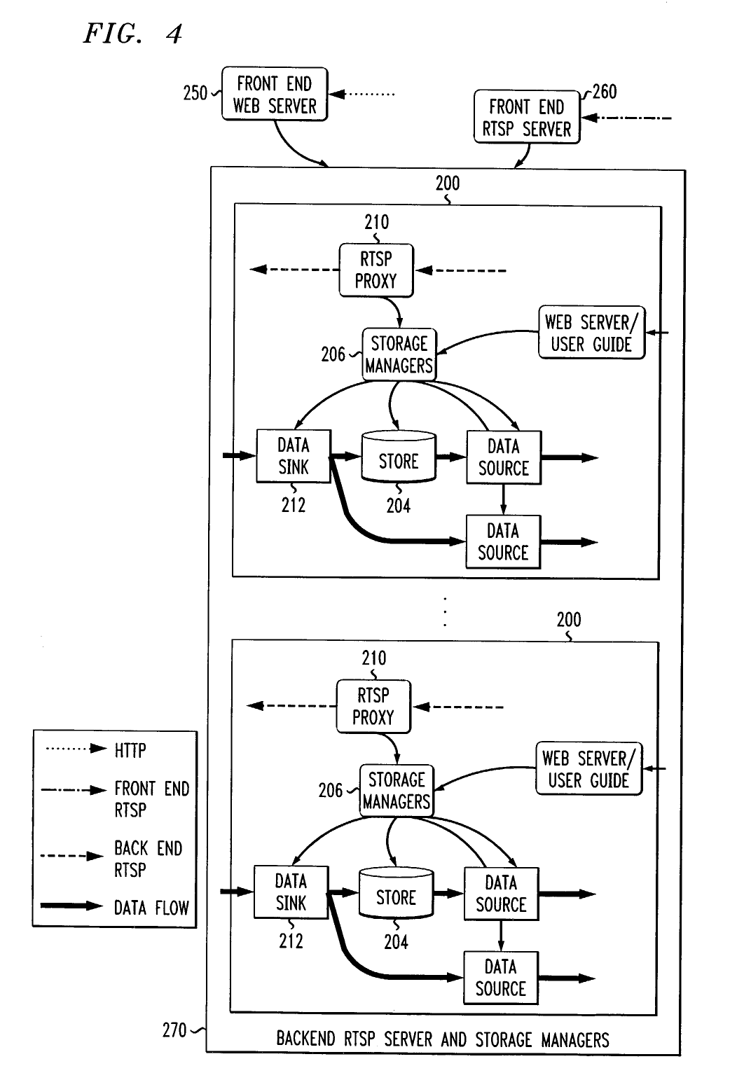

The portal architecture lends itself to a number of implementation options depending on the required scalability. In the simplest case a small replay portal 200 can have all the components executing on a single physical machine. This is the nature of the prototype implementation which is discussed in more detail hereinbelow. As illustrated in FIG. 4, a more scalable realization could involve a frontend web server 250 and frontend RTSP server 260 which hand-off processing of streaming content to a farm of backend RTSP servers and storage managers 270. In this case access to the RTSP portal 210 through the web interface server 250 will result in one of the backend servers 200 being chosen based on server load, the content to be accessed or some other policy. Similarly direct accesses to the RTSP portal 210 interface, handled by the RTSP frontend, will be handed off to one of the backend servers.

The data path handling of streaming content can similarly be realized in a variety of implementations. Again in the simplest case an RTSP proxy server 210 and a storage manager 206 in combination can simply execute on a single server machine potentially with two network interfaces. In such an implementation the RTSP proxy server 210 could however easily become a bottleneck, as it has to handle re-delivery of any live streams as well as any on-demand delivery of streams.

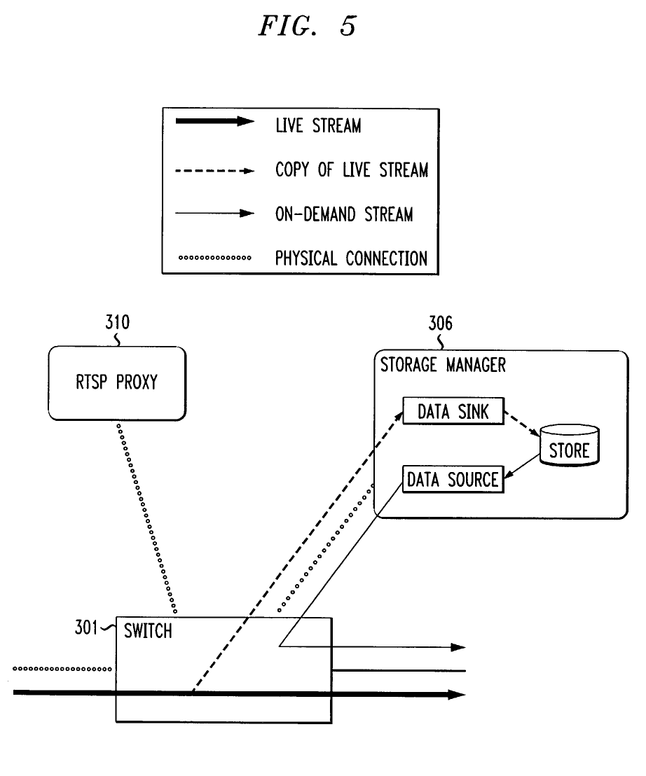

An alternative realization is depicted in FIG. 5. In this case an RTSP proxy 310 and its associated storage manager 306 are separated by means of a forwarding device such as a switch 301 or a router. As before the storage manager 306 is effectively controlled by the RTSP proxy 310 based on user requests. The RTSP proxy 310 also has some control over the forwarding device. In particular the RTSP proxy 310 can instruct the switch 301 to have a copy of a particular stream delivered on the switch interface connected to the storage manager 306. As before, the RTSP proxy 310 instructs the storage manager 306 to expect and store this stream. In this case the storage manager 306 does not handle the live stream at all and is only responsible for handling any on-demand requests.

In order to demonstrate the feasibility of the present invention a prototype system has been developed consisting of all the elements in the architecture a live server, a replay portal (consisting of web server, RTSP proxy and storage managers) and a streaming client.

To provide high quality service, an MPEG-2 encoding is used for the video streams making use of hardware encoders and decoders, however, other encodings are possible within the scope of the invention. Alternative encodings that are implemented in software may allow additional flexibility at the client to support decoding of multiple simultaneous streams, which may not be cost effective with an encoding that requires a dedicated hardware decoder at the client. The description of the invention discusses an MPEG-2 encoding as one that is representative of current technology.

RTSP proxy 210 and/or 310 is the control protocol that binds all of the components together. An RTSP library (librtsp) has been developed which has been derived from an early public domain implementation from Real Networks. The portal is implemented on a Linux infrastructure and the web server is an unmodified Apache server.

From the outset the present invention deals with a diversity of platforms and operating systems, code portability is a major concern. A basic portability library (libcommon) is developed that dealt with operating system specific issues and provides a common interface to other libraries and applications. Each of these libraries and the applications built on them are discussed in more detail hereinbelow.

The main functions provided by libcommon are an event scheduling mechanism and IO handling of both network and file systems across all supported platforms. The event scheduling mechanism allows specific functions to be called based on time, network or file events. This includes the running of “background” tasks when the system is idle. Libcommon also contains a number of general mechanisms such as safe string handling and ring buffer and table manipulation.

Librtsp builds on libcommon and provides a simple way for either client or server applications to use RTSP. For example a client application simply calls “rtsp_connect” to initiate communication with an RTSP server. On success the client obtains a handle with which all further interaction with the server (i.e. describe, play etc.) is conducted through a remote procedure call (RPC) like interface. The library deals with message formatting and parsing and presents the content of messages to the application in the form of well defined structures, or forms RTSP messages out of structures provided by the application.

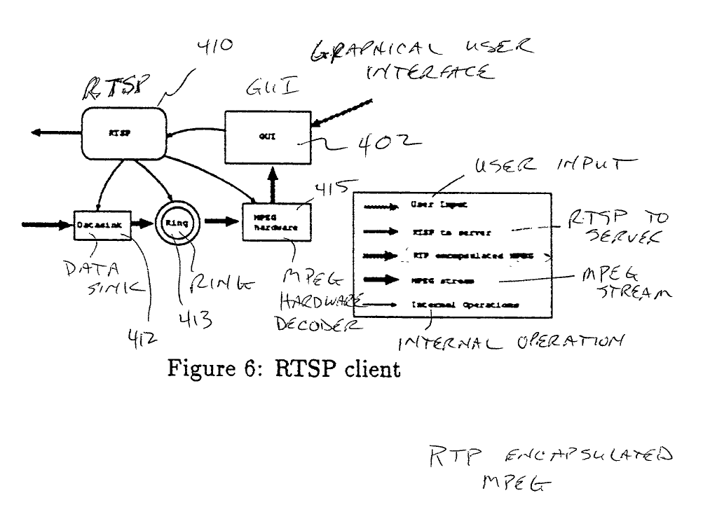

The structure of the client software is depicted in FIG. 6. A graphical user interface (GUI) 402 allows the user to specify the RTSP URL 410 of interest and initiate streaming. As explained earlier, an alternative is for the URL to be supplied to the client software by means of a helper file downloaded by a web browser on the client device. On successful RTSP 410 interaction with the server, the client sets up a datasink 412 and a ring buffer 413 and initiates the MPEG hardware decoder 415. The datasink 412 receives an RTP encapsulated MPEG stream from the network, strips off the RTP encapsulation and puts the MPEG packets in the ring buffer 413 for asynchronous collection by the MPEG decoder hardware 415. The decoder driver performs an upcall into the application whenever its buffers are below a certain threshold at which point data is transferred from the ring buffer 413 to the decoder 415.

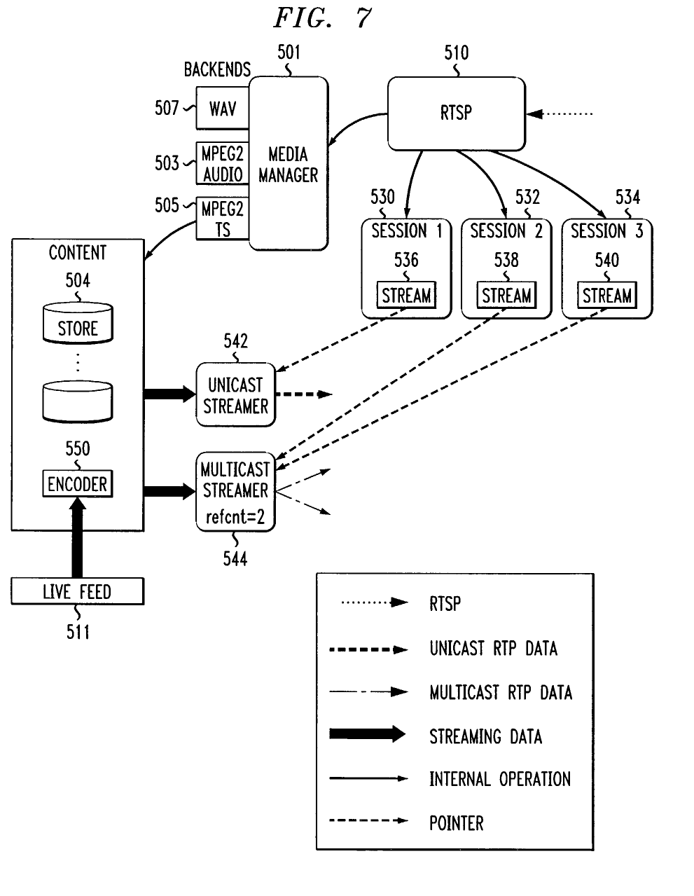

FIG. 7 shows the main components of a RTSP server 510 implementation. RTSP requests received by the RTSP library are passed to a Media Manager 501 which determines if there is a media backend that can handle a request of this type. A number of media specific backends have been implemented namely backends for MPEG2 audio 503, MPEG2 transport 505 and WAV streams 507. These backends deal with media specific issues such as the frame format of streams, the rate at which streams should be played out and how to encapsulate media frames in RTP. The content on which the backends operate can be stored on disc to be supplied in real time from an encoder. For example, a live server 511 is implemented as an encoding thread which supplies an MPEG stream to an encoder 550 and then to an MPEG transport stream backend. The content contained in the store 504 or in the encoder 550 is selectively supplied to the unicast streamer 542 or the multicast streamer 544.

Once the Media Manager has determined that the requested content is available, i.e. a successful, RTSP DESCRIBE interaction, the client application normally issues RTSP SETUP and PLAY requests. The SETUP request results in session states 530, 532, 534, etc. being created in the RTSP server 510 and streamers 536, 538 and 540 are initialized to deliver the stream. A PLAY request starts delivery of the stream. The session state 536 contains stream information that is relevant for this stream for this session (e.g. the time a session joined a stream), whereas the streamer contains only session independent information about the stream. The streamer 536 supplies content to the unicast streamer 542 for unicast RTP data transmission. This separation is important in order to deal with the streams 538 and 540 that deal with multicast streams. For example, the streamers 538 and 540 supply content to the multicast streamer 544 for multicast RTP data transmission. The first client to request delivery of a multicast stream will result in a streamer being created. Subsequent sessions for the same stream will be served by the same streamer and a reference count in the streamer ensures that the streamer does not disappear when the initial session is terminated.

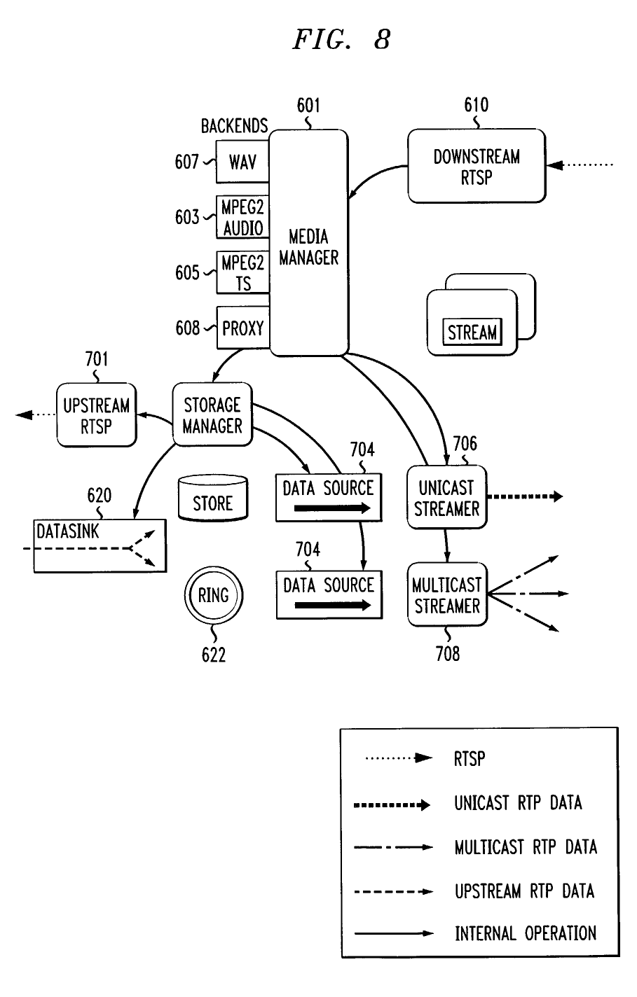

As illustrated in FIG. 8, the RTSP proxy functionality required by the replay portal is realized by having the proxy 608 as another media backend. As is the case with other backends, the proxy 608 backend determines whether a request can be satisfied from its local stored content. However in the case of the proxy 608, the RTSP server 610 address of the RTSP URL is not the proxy address and if the request can not be satisfied locally the proxy 608 backend can issue an upstream RTSP request to the RTSP server 610 specified in the URL.

A downstream RTSP 610 supplies RTSP data to a media manager 601. The media manager 601 includes backends WAV 607, MPEG2 audio 603, MPEG2 transport 605 and the proxy 608. RTSP data is supplied from the proxy 608 to the storage manager 606. Subsequently, RTSP data can be supplied to an upstream RTSP 701, a datasink 620 or to data sources 704. A store 604 and a ring 622 are operatively connected to the storage manager 604, the datasink 620 and the data source 704. The media manager 601 can supply unicast RTP data to a unicast streamer 706 for supply to a customer. The media manager 601 can also supply multicast RTP data to the multicast streamer 708 for supply to a plurality of customers.

If the request can be satisfied from the local store, a streamer is set up as described above and the stream is delivered to the client. If content is received from upstream, the datasink 620 will receive the packets writing it to disc and putting a copy in the ring buffer 622 for delivery to live viewers of the stream if any. In this case the proxy 608 backend content is stored to a disk intact with the RTP header it was received with. Subsequent playout of stored content is then based on the RTP timestamp of the stored packets while the RTP sequence numbers are replaced for retransmitted downstream delivery. Storing content in the proxy 608 with RTP headers intact has the desirable property that the proxy 608 is media independent so long as the stream is delivered using RTP.

The storage manager(s) 601 handle the manipulation of stored content. This includes the eviction policy associated with a particular stream. In the case of portal subscribed content which is made available for on-demand viewing one possible storage policy is simply to keep the last N hours worth of content. This is implemented as a logical circular set of files where the oldest file gets overwritten after N hours with new content. In order to have the N hour window move forward in time with a small granularity and to ease time based indexing into the stored content each of these files holds a relatively small amount of data, in the order of one or two minutes worth of content.

In the case of a user watching non-portal subscribed content through the portal, the store manager 601 in the proxy 608 still stores some amount of the content to disk. This is needed to facilitate replay of very recent content, i.e. in the order of the last few minutes. The eviction policy of the storage manager 601 may be much more aggressive for non-subscribed content, however, if the portal only provides a small replay window for this content.

A Unix filesystem may not be ideal for storing and indexing media for the present invention. Scalable systems would need to pull control off the datapath or realize a streaming specific file system. It is possible to build media-agnostic proxy by using RTP timestamps, but only if the media encoding's clock rate is known. This can typically be obtained from the RTSP interaction.

If we focus the discussion on a single replay portal then its functionality is a subset of the functionality provided by consumer electronic devices such as those provided by TiVo and ReplayTV. The products of these companies are very similar both sell a combination of a hardware device and a TV listings service. The devices include MPEG2 encoder/decoder hardware and a hard disk in a box which is daisy-chained in between the cable or aerial feed and the TV. It can simultaneously record a TV channel to disk as an MPEG stream while reading and playing back a previously recorded program. This, combined with TV schedule information and firmware control of the processes allow these devices to perform many of the functions associated with a stand-a-lone replay portal. Since both devices only include one tuner, they cannot record more than one channel at any time.

The crucial difference between these devices and the solution presented in the present invention is that the replay portal is a networked device from which a number of additional benefits are derived. The portal being a networked entity enables sharing of content on the same portal between customers and sharing of content between different portals. Also, as indicated above the replay portal architecture avoids the blanket broadcasting of content across access networks which is not possible with regular consumer electronic devices. Finally, in the replay portal architecture a user is not limited in the number of simultaneous recordings that can be performed by tuner limitations in a home device. Since all storing of content happens inside the network, on shared service provider infrastructure, a user might be simultaneously recording multiple streams (at the portal) while watching any one of these (or indeed any other stream) live.

Another important area of the present invention relate to Internet based content distribution. Current product and service offerings in this space mainly cater for web traffic which still dominates by far as the main Internet traffic type. However, the Internet is now starting to support streaming content. One part of the problem solved by these offerings revolves around on-demand streaming of fairly short (low quality) clips where the objective and solution is very similar to that of Web content, i.e. to get content closer to users and to make intelligent choices as to what server will serve a particular request. The problem is generally addressed by creating an overlay network of cooperating content distribution servers which interact with each other and the actual content servers to offer total balancing, redundancy and reduced latency. In the domain of live streaming content the overlay network can also provide efficient application level distribution trees between the content distribution servers and offer retransmission facilities in the overlay network to compensate for the lack of such mechanisms in streaming protocols. Indeed one of the major problems with current streaming offerings is the lack of standard protocols on which to transfer streaming content. This means that content distribution server vendors are required to support a number of proprietary protocols in order to realize their goals thus increasing the price and complexity of their product. More seriously though is the fact that these proprietary protocols are not subjected to the same amount of scrutiny TCP has undergone and its impact on the stability of the Internet is therefore unknown. The replay portal architecture presented in the present invention will require a content distribution mechanism in order to get content to portals and to exchange content between portals. These aspects are the focus of the present invention from the single stand-a-lone portal to a set of cooperating portals.

The present invention relates to video-on-demand (VOD). The work presented here is not limited to VOD in the “traditional” sense where video content is somehow uploaded to a server and then made available for on-demand viewing. Rather in the present invention, live schedule-based content can also be made available for on-demand viewing as soon as it has been “aired.” Nonetheless, as soon as content is viewed on-demand, many of the techniques and methods developed for VOD will be applicable in the present invention. For example, access to popular content might well benefit from batching or patching techniques.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An internet network based video replay system adapted for enabling a customer to view a video program comprising:
a network for providing a plurality of access programs selectively available to enable a customer to view a selected program;
wherein the network stores a plurality of video programs for a predetermined period of time to permit customers to view selected programs upon demand.

2. The internet network based video replay system according to claim 1, wherein said video programming is live programming of events that is stored for a predetermined period of time to permit a user to time shift viewing of selective programs upon demand.

3. The internet network based video replay system according to claim 1, and further including a replay portal for storing a plurality of programs and enabling a customer to selectively retrieve a selected program for viewing.

4. The internet network based video replay system according to claim 3, wherein said replay portal stores an individual program for a predetermined period of time for selective viewing by a customer

5. The internet network based video replay system according to claim 4, wherein after a predetermined period of time the individual program is recorded over to enable a customer to retrieve one of a revised selection of a plurality of programs.

6. The internet network based video replay system according to claim 3, wherein a high capacity backbone is provided to permit the replay portal to receive programs from live sources and from broadcasts for retransmission to customers.

7. The internet network based video replay system according to claim 3, wherein a replay portal receives programs from other replay portals for retransmission to customers.

8. The internet network based video replay system according to claim 1, and further including a primary hub for distributing programs to a secondary hub and fiber optical connections from the secondary hub to a fiber node for retransmission to individual customer homes.

9. The internet network based video replay system according to claim 1, wherein said network includes a data sink for receiving network programs and live programs from a provider, a storage unit for receiving said network programs and live programs from the data sink and a data source for providing downstream viewing of selected programming.

10. The internet network based video replay system according to claim 9, and further including a storage manager unit for managing the selection of a particular program by a customer and for addition and removal of data from a store.

11. The internet network based video replay system according to claim 10, wherein said storage manager is operative connected to a data sink for receiving data from upstream and writing the data to the store for a particular customer while making the data available for immediate delivery to a customer.

12. The internet network based video replay system according to claim 9, and further including a media manager for managing the selection of a particular program by a customer, said media manager including a backend frame format means for determining the encapsulation of media frames in real transport protocol.

13. The internet network based video replay system according to claim 1, wherein a customer is enabled to view, still pause, reverse and fast forward the viewing of the video program.

14. The internet network based video replay system according to claim 1, wherein the acquiring of the video program is by a unicast real time transport protocol or any other unicast protocol.

15. The internet network based video replay system according to claim 1, wherein the acquiring of the video program is by a multicast real time transport protocol or other multicast protocol.

16. The internet network based video replay system according to claim 1, wherein the acquiring of the video program is by inter portal communication.

17. An internet network based video replay system according to claim 16, wherein the transfer is by a unicast real time transport protocol or any other unicast protocol.

18. An internet network based video replay system according to claim 16, wherein the transfer is by a multicast real time transport protocol or any other multicast protocol.

19. An internet network based video replay system adapted for enabling a customer to view a video program comprising:
a network for providing a plurality of access programs selectively available to enable a customer to view a selected program; and
a replay portal for storing a plurality of programs for enabling a customer to selectively retrieve a selected program for viewing;
wherein the replay portal stores a plurality of video programs for a predetermined period of time to permit customers to view, still pause, reverse and fast forward the viewing of selective programs upon demand.

20. The internet network based video replay system according to claim 19, wherein said video programming is live programming of events that is stored for a predetermined period of time to permit a user to time shift viewing of selective programs upon demand.

21. The internet network based video replay system according to claim 19, wherein said replay portal stores an individual program for at least one of a predetermined period of time and an undetermined period of time for selective viewing by a customer.

22. The internet network based video replay system according to claim 21, wherein after a predetermined period of time the individual program is recorded over to enable a customer to retrieve one of a revised selection of a plurality of programs.

23. The internet network based video replay system according to claim 19, wherein a high capacity backbone is provided to permit the replay portal to receive programs from live sources and from broadcasts for retransmission to customers.

24. The internet network based video replay system according to claim 19, wherein a replay portal receives programs from other replay portals for retransmission to customers.

25. The internet network based video replay system according to claim 19, wherein said network includes a data sink for receiving network programs and live programs from a provider, a storage unit for receiving said network programs and live programs from the data sink and a data source for providing downstream viewing of selected programming.

26. The internet network based video replay system according to claim 25, and further including a storage manager unit for managing the selection of a particular program by a customer and for addition and removal of data from a store.

27. The internet network based video replay system according to claim 26, wherein said storage manager is operative connected to a data sink for receiving data from upstream and writing the data to the store for a particular customer while making the data available for immediate delivery to a customer.

28. The internet network based video replay system according to claim 25, and further including a media manager for managing the selection of a particular program by a customer, said media manager including a backend frame format means for determining the encapsulation of media frames in a real time transport protocol.

29. The internet network based video replay system according to claim 19, wherein the acquiring of the video program is by a unicast real time transport protocol or by any other unicast protocol.

30. The internet network based video replay system according to claim 19, wherein the acquiring of the video program is by a multicast real time transport protocol or by any other multicast protocol.

31. The internet network based video replay system according to claim 19, wherein the acquiring of the video program is by inter portal communication.

32. The internet network based video replay system according to claim 31, wherein the transfer is by a unicast real time transport protocol or any other unicast protocol.

33. The internet network based video replay system according to claim 31, wherein the transfer is by a multicast real time transport protocol or any other multicast protocol.

34. An internet network based video replay system adapted for enabling a customer to view a video program comprising:
a network for providing a plurality of access programs selectively available to enable a customer to view a selected program; and
a customer replay portal for storing a plurality of programs for enabling a customer to selectively retrieve a selected program for viewing;
wherein the customer replay portal is maintained by said customer to store a plurality of video programs for at least one of a predetermined period of time and an undetermined period of time to permit the customer to view, still pause, reverse and fast forward the viewing of selective programs upon demand.

35. The internet network based video replay system according to claim 34, wherein said video programming is live programming of events that is stored for a predetermined period of time to permit a user to time shift viewing of selective programs upon demand.

36. The internet network based video replay system according to claim 34, wherein a high capacity backbone is provided to permit the customer replay portal to receive programs directly from live sources and from broadcasts

37. The internet network based video replay system according to claim 34, and further including a media manager for managing the selection of a particular program by a customer, said media manager including a backend frame format means for determining the encapsulation of media frames in a real time transport protocol.

38. The internet network based video replay system according to claim 34, wherein the acquiring of the video program is by a unicast real time transport protocol or any other unicast protocol.

39. The internet network based video replay system according to claim 34, wherein the acquiring of the video program is by a multicast real time transport protocol or any other multicast protocol.

40. The internet network based video replay system according to claim 34, wherein the acquiring of the video program is by inter portal communication.

41. The internet network based video replay system according to claim 40, wherein the acquiring of the video program is by transfer from a network based portal operated by a service provider.

42. The internet network based video replay system according to claim 40, wherein the acquiring of the video program is by transfer from a network based portal operated by another customer.
